(19) United States
(12) Patent Application Publication
(10) Pub. No.: US 2024/0085199 A1
(43) Pub. Date: Mar. 14, 2024

(54) SMART ROAD SALT DISTRIBUTION SYSTEM WITH BLOCKCHAIN NETWORK

(71) Applicant: FORD GLOBAL TECHNOLOGIES, LLC, DEARBORN, MI (US)

(72) Inventors: Mahmoud Y. Ghannam, Canton, MI (US); Noha Ghannam, Canton, MI (US)

(21) Appl. No.: 17/944,316

(22) Filed: Sep. 14, 2022

(51) Int. Cl. G01C 21/34; B60W 40/06

(52) U.S. Cl. CPC G01C 21/3461; B60W 40/06; B60W 2555/20

(57) ABSTRACT

A road salt distribution system uses a plurality of agents cooperatively undertaking activities in order to apply salt (or other substances) for treating roadways. Each agent has a respective agent computing device. The computing devices are interconnected as nodes within a permissioned blockchain network. The agents include a salt-spreading agent and an administrative agent. A permissioned blockchain ledger is shared among the agent computing devices which comprises a series of transactions according to the cooperatively undertaken activities. Each transaction has a respective transaction type such as a routing transaction and a salt-deposited transaction. The agent computing devices (1) generate a proposed transaction when undertaking one of the activities, (2) confirm a proposed transaction record if the respective activity can be verified; (3) add the proposed transaction to the blockchain ledger if the proposed transaction has been confirmed; and (4) conduct is road-salt-related functions using data extracted from the blockchain ledger.

### CROSS REFERENCE TO RELATED APPLICATIONS

Not Applicable.

### STATEMENT REGARDING FEDERALLY SPONSORED RESEARCH

Not Applicable.

### BACKGROUND OF THE INVENTION

The present invention relates in general to roadway maintenance using salt, sand, or other substances which are spread to reduce ice and snow, and, more is specifically, to a data network system and method for operating a salt distribution system using distributed data with high reliability to improve the effectiveness of keeping roads clear with a minimal consumption of salt or other treatment substances.

To melt existing ice and to prevent the accumulation of new ice on winter roads, highway crews may be deployed to spread salt. A typical salt-spreading truck has little or no ability to adjust the quantities of salt that are discharged on the roadway while the truck traverses the roadway. Consequently, a fixed amount is typically spread across all the roads being serviced. It would be beneficial to use less salt by exerting control over the amount of salt being spread since a lot of the salt can end up in unintended ecosystems. Controlling the amount of salt can help decrease the impact on the environment while reducing costs.

Besides salt, other solids or liquids can be used such as sand or ash. Each alternative substance represents its own economic and environmental costs which it is desired to keep under control.

In addition, there has been a lack of accountability between different parties involved in salt/treatment distribution. In addition to the mobile spreading vehicles (e.g., trucks), these parties may include administrative parties such as a governmental authority in charge of dispatching of road maintenance crews (e.g., country road commission), a salt supplier or loading facility, and an end-customer coordinator (e.g., home/condo association or a commercial property manager). Trust among the administrators and the spreading vehicles may be eroded due to haphazard monitoring, salt runoff, or incomplete communications. To compensate for such factors, an excessive amount of salt may be distributed in an attempt to increase the likelihood that an area was visited by a spreader vehicle and that the area was salted. Consequently, the use of salt in the U.S. has skyrocketed over time— from 0.15 metric tons (0.16 tons) per year during the 1940s to about 18 million metric tons (19.8 million tons) per year today. Through better monitoring and use of adaptive control, the spreading of excessive salt or other substances can be avoided.

### SUMMARY OF THE INVENTION

There is a need for a trusted and controlled salt distribution solution based on road conditions and locations, wherein data is collected and used to mitigate is environmental damage, reduce costs, and create less damage to the roads. Authentication of users and second party confirmation of salt-related activities achieve the desired improvements.

The invention provides an at least partially closed system with predefined nodes in a permissioned blockchain network to secure and authenticate salt distribution on roads, within subdivisions, at intersections, or elsewhere along a directed route. In the permissioned blockchain, a plurality of agents (i.e., users) are relevant entities interconnected as nodes in the blockchain network, and may include a salt loading station, salt distribution/spreading vehicles, a distribution fleet manager, and/or a road authority (e.g., road commission, property owner association, city or county government organization). The nodes may undertake various salt-related activities to request, plan, and/or execute the spreading of salt using consensus and validating processes among themselves constructed as smart contracts. Each smart contract may include a set of rules which specifies the requirement for qualifying certain transactions to be included in a blockchain ledger which is shared among the authorized agents. The blockchain provides a shared database which includes authenticated records as transactions according to predetermined transaction types. By ensuring that a correct amount of salt is identified and then communicated, instances of a missed distribution of salt or a spreading of an improper amount of salt are avoided.

In one aspect of the invention, a road treatment distribution system (e.g., road salt distribution system) includes a plurality of agents cooperatively undertaking activities in order to apply substances for treating roadways. A plurality of agent computing devices are each operated by a respective agent, wherein the agent computing devices are interconnected as nodes within a permissioned blockchain network, and wherein the agents include at least one substance-spreading agent and at least one administrative agent. A permissioned blockchain ledger is shared among the agent computing devices which comprises a series of transactions according to the cooperatively undertaken activities. Each transaction in the series in blockchain ledger has a respective transaction type according to a predetermined list of is transaction types which includes a routing transaction and a substance-deposited transaction. The agent computing devices are configured to (1) generate a proposed transaction when undertaking one of the activities, (2) confirm a proposed transaction record received from another one of the agent computing devices if the respective activity can be verified; (3) add the proposed transaction to the blockchain ledger if the proposed transaction has been confirmed; and (4) conduct road-substance-related functions using data extracted from the blockchain ledger.

### BRIEF DESCRIPTION OF THE DRAWINGS

FIG. 1 is a schematic diagram of a road salt distribution system and a serviced system of roadways.

FIG. 2 is a network diagram showing agents and other entities interconnected via a permissioned blockchain network and a public blockchain network.

FIG. 3 is a diagram showing an example blockchain having a linked list of transactions.

FIG. 4 is a flowchart showing one preferred method of the invention.

### DETAILED DESCRIPTION OF PREFERRED EMBODIMENTS

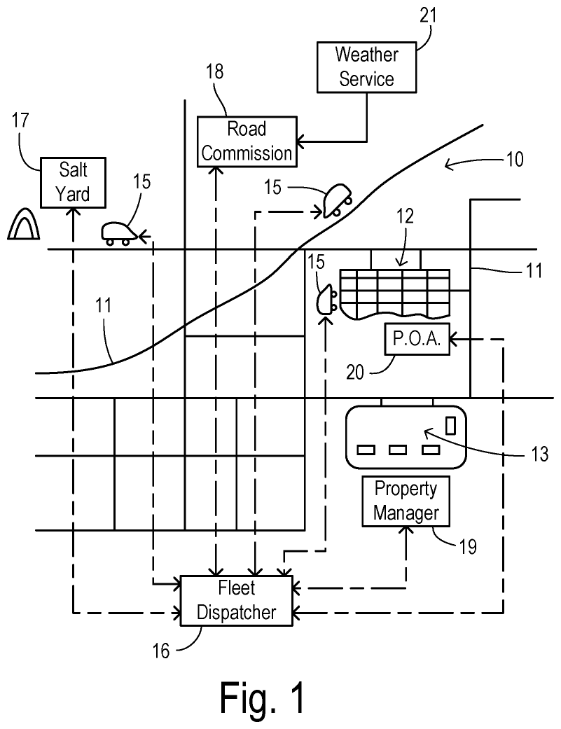

Referring to FIG. 1, a roadway system 10 includes a plurality of streets and highways 11, subdivision roads 12, and parking lot(s) 13 in a commercial office park or a shopping mall, for example. A road salt distribution system includes a plurality of salt spreader vehicles 15 such as trucks with salt spreading equipment and plows. During cold winter weather including precipitation of ice and/or snow, spreader vehicles 15 are dispatched to apply salt to roadway system 10 by a fleet dispatcher 16. Spreader vehicles 15 utilize loads of salt obtained at a salt yard 17. Although this description specifically refers to salt as a treatment substance, it applies equally to the use of other substances such as sand, ash, other solids for melting snow and ice or increasing traction, and any liquids achieving the same effects.

Fleet dispatcher 16 may be a public or private entity in communication with is spreader vehicles 15. Dispatcher 16 may instruct vehicles 15 to perform specific spreading activities in response to road maintenance requests from a road commission 18 (e.g., city or county authority), a property manager 19 responsible for parking lots 13, and/or a property owners association 20 responsible for subdivision roads 12. Road commission 18 (as well as property manager 19 and property owners association 20) may consult a weather service 21 as well as other sources of data to determine a need for various activities performing road-salt-related functions such as spreading of salt onto various roads and preparatory loading of salt onto spreader vehicles.

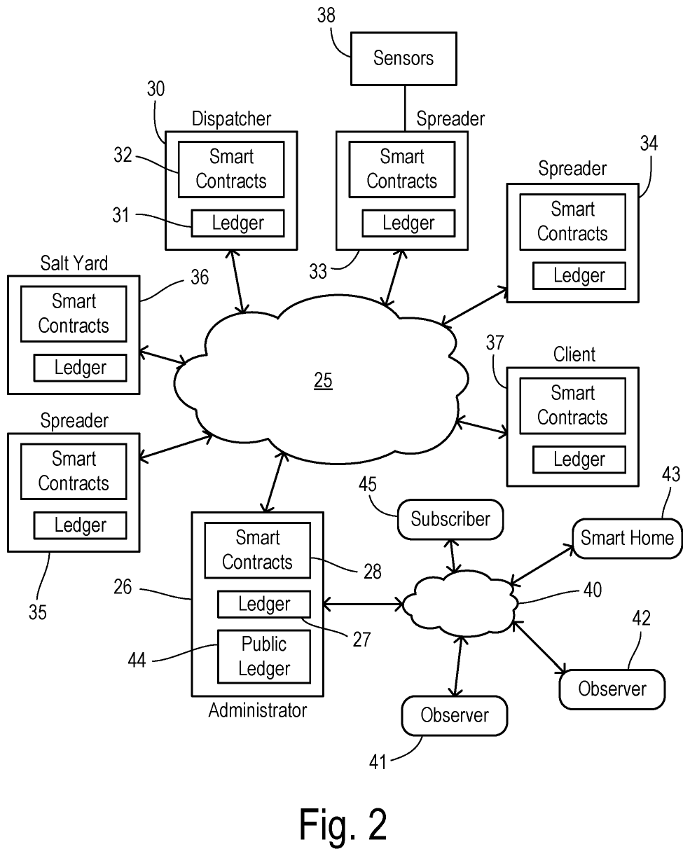

FIG. 2 provides a diagram showing a permissioned blockchain network coupled through a data network 25, such as the Internet. Commercial networking hardware and software products are available for implementing blockchain systems. A general discussion of an example of blockchain networking is provided in U.S. Pat. No. 11,416,548, issued Aug. 16, 2022, entitled “Index Management for a Database.”

Each agent in the road salt distribution system has a respective agent computing device coupled to network 25. For example, an administrator computing device 26 stores a local copy of a permissioned blockchain ledger 27 along with program instructions for performing blockchain related functions such as a set of smart contracts 28. A dispatcher computing device 30 has its own local copy of ledger 31 and its own set of smart contracts 32. In some embodiments, administrator device 26 may be associated with a county road commission or other governmental entity. Dispatcher device 30 may be associated with a public organization (e.g., a governmental subunit or department) or a manager of a private fleet of spreading vehicles. In some embodiments, an administrator agent and dispatcher agent may be combined as a single entity.

Nodes in network 25 is each assigned security credentials for obtaining access to the permissioned blockchain functions. Credentials may be comprised of a password or a combination of a secret key and a common key which enable other nodes to authenticate various messages and to limit sharing of the permissioned blockchain ledger. is Smart contracts 28 and 32 may define various types of transactions such as a routing transaction or a salt loading transaction. For each transaction, the smart contracts may define associated activities, predefined rules for querying other nodes (i.e., other agent computing devices), and rules for forming consensus or verification of proposed additions to the permissioned blockchain ledger.

Additional agents which are nodes on network 25 include a plurality of spreader vehicles 33, 34, and 35, each of which incorporates respective smart contracts and local copies of the blockchain ledger. The smart contracts of spreader vehicles 33-35 are configured to interact with dispatcher device 30 in connection with establishing road routes and salt quantities for spreading salt as needed. Additional smart contracts provide for transactions which report amounts of salt that have been deposited in response to a route.

A salt yard agent has an associated computing device 36 with associated smart contracts and a local copy of the blockchain ledger. Likewise, client agents such as a commercial property manager or a home owners association may have an associated computing device 37 with its corresponding smart contracts and copy of the ledger.

A spreader vehicle which includes spreader computing device 33 may also include environmental sensors 38 for remotely collecting road condition data in the vicinity of the spreading vehicle. Sensors 38 may include cameras, ambient temperature sensors, radar, Lidar, wheel slip sensors, and the like. In an environmental-data transaction which may be initiated according to a smart contract in computing device 33, road condition data is shared with and confirmed by an administrative agent (such as the administrator agent or dispatcher agent) for addition to the blockchain ledger.

In order to expand the scope of available environmental and road condition data, members of the public may be enlisted to provide environmental sensor data to the administrator agent via a public network connection 40. For example, observer vehicles 41 and 42 (each of which is equipped with appropriate environmental sensors and communication systems for transmitting the resulting data) are coupled via a public network 40 to administrator computing device 26. Administrator computing device 26 maintains a public blockchain ledger 44 which compiles environmental/road condition data including contributions collected from observers 41 and 42. Public ledger 44 can be used to facilitate analysis of road conditions and determine needs for salt application to particular roads. To incentivize members of the public to participate in providing environmental data via public blockchain ledger 44, an administrative entity such as the road commission or home owners association may provide rewards to the owners of observer vehicles 41-43 to compensate for their participation. For example, points which are redeemable for various gifts or other compensation may be awarded to the respective users when the observer vehicles provide sensor data. Public ledger 44 builds up a database of environmental data for use in determining the appropriate salt-related activities. Public ledger 44 may likewise be shared with the other computing devices of the permissioned nodes for use in defining their salt-related activities. Information from public ledger 44 and/or ledger 27 may further be shared with data subscribers 45 interested in the salt-related activities, such as insurance companies.

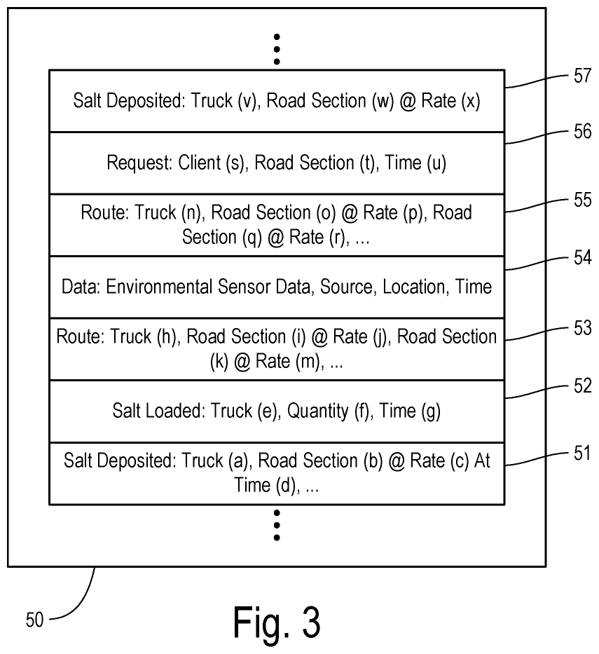

An additional source of data includes sensors located at the target roadways being treated. For example, a smart home 43 may provide camera image data which can be inspected to detect the time and nature of actions taken by a spreader vehicle at a target location (e.g. driveway or roadway in front of a home). Before and after images from smart home 43 may be added to ledger 44 and/or ledger 27 to be used for verification of transactions. In addition to private homes, camera image data could be provided by other commercial or residential facilities. Such image data can increase safety for drivers and pedestrians in the vicinities of these facilities and homes by more quickly identifying a need for treatment and obtaining verification of treatments. FIG. 3 shows an example of a blockchain 50 which consists of a plurality of linked blocks 51-57 of sequential transactions, each of which has previously been proposed and verified. The most recent transactions are listed toward the top of the figure, with subsequent transactions being added to blockchain 50 at the top. The example transactions include a block 51 defining a salt-deposited transaction which is specifies an identity of a spreader vehicle which performed the salt spreading together with a list of road sections where the salt was spread and the salt spreading rate used at the various sections along the route and the time the salt was spread. A salt deposited transaction may be triggered by a user in a spreader vehicle by a manual command once a route is completed, or may be generated automatically when a spreader vehicle is determined by location tracking to have completed a particular route. The road sections may be defined according to geographic coordinates, street names and numbers, or any other system to reliably direct the spreading vehicles.

A block 52 shows an example of a salt-loaded transaction which specifies an identity of a salt spreader truck, a quantity of salt loaded on the truck, and the time of the loading, for example. A salt-loaded transaction may be initiated by either a spreader vehicle or a salt yard agent and may be verified by the other of those.

A routing transaction block 53 is shown which was initiated by an administrative agent and then received by and verified by a target spreader vehicle. Block 53 includes data which identifies the assigned spreader truck, one or more defined road sections, and the corresponding salt spreading rates to be used along the route to achieve a desired salt coverage.

In a block 54, a Data transaction is linked into the blockchain containing environmental sensor data, an identification of source of the data, a location corresponding to collected sensor data, and the time of collection. The environmental sensor data in the Data transaction can be accessed by all the permissioned nodes that receive the blockchain ledger. The data can be extracted and used to define road condition data that may be used at a routing node for determining a corresponding salt distribution route and salt quantity which is then entered into blockchain 50 as a block 55.

A block 56 depicts a Request transaction which may be initiated by a client agent such as a property manager, home owners association, or any other potential recipient of salt on a particular roadway. If a recipient verifies the request, block 56 is included in blockchain 50. The Request type transaction may specify the client making a request, corresponding road sections to be salted, and a desired time for is completion of the spreading of salt.

Block 57 shows another salt-deposited transaction in which a spreader vehicle identified in the transaction reports road sections and salt quantities that have been delivered.

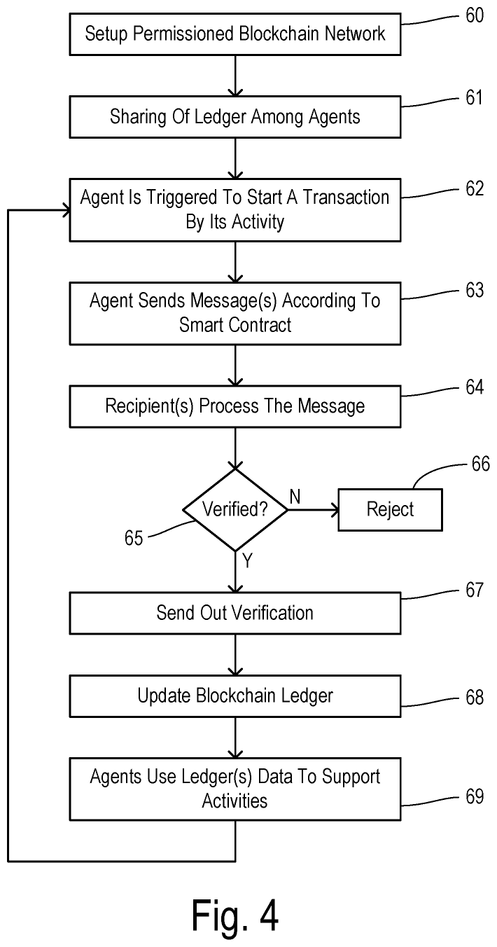

FIG. 4 shows one preferred method of the invention wherein a permission blockchain network is set up in step 60 by interconnecting a plurality of agent computing devices operated by respective agents. The agents include at least one salt spreading agent and at least one administrative agent. In step 61, a permissioned blockchain ledger is shared among the agent computing devices. The permissioned blockchain ledger comprises a series of transactions according to cooperatively undertaken activities performed by the agents in spreading road salt. Respective transaction types for the series of transactions includes a Routing transaction and a Salt-Deposited transaction.

In step 62, an agent is triggered to start a transaction as a result of its activities undertaken as part of the road salt distribution system. The activities reflected in each respective transaction may include (A) loading of salt on a spreader vehicle, (B) routing instructions for following a particular route while delivering specified quantities of salt, (C) requests for delivery of salt to particular clients or customers responsible for corresponding sections of roads, or (D) a salt-deposited transaction which defines locations where salt has been spread and the quantities spread. Once an agent has been triggered to start a transaction, it sends appropriate messages to other agents according to a respective smart contract which defines the requirements of a transaction and rules for verification of transactions before they can be included in the blockchain. In step 64, recipients process the messages received according to the corresponding smart contract in the recipient computing device. In step 65, a check is performed to determine whether the requested transaction is verified. If not, then a request is rejected in step 66. If verified, then the recipient (or recipients) send out verification in step 67 so that the shared blockchain ledger can be updated in step 68. With the updated blockchain ledger, agents use the data in the updated ledger to support their respective salt related activities in step 69. Thereafter, is steps 62-69 may be repeated according to the ongoing activities of all the permissioned nodes.

What is claimed is:

1. A road treatment distribution system in which a plurality of agents cooperatively undertake activities in order to apply substances for treating roadways, comprising:
a plurality of agent computing devices each operated by a respective agent, wherein the agent computing devices are interconnected as nodes within a permissioned blockchain network, wherein the agents include at least one substance-spreading agent and at least one administrative agent; and
a permissioned blockchain ledger shared among the agent computing devices which comprises a series of transactions according to the cooperatively undertaken activities, wherein each transaction in the series in blockchain ledger has a respective transaction type according to a predetermined list of transaction types which includes a routing transaction and a substance-deposited transaction;
is wherein the agent computing devices are configured to (1) generate a proposed transaction when undertaking one of the activities, (2) confirm a proposed transaction record received from another one of the agent computing devices if the respective activity can be verified; (3) add the proposed transaction to the blockchain ledger if the proposed transaction has been confirmed; and (4) conduct road-substance-related functions using data extracted from the blockchain ledger.

2. The road treatment distribution system of claim 1 wherein the agents include at least one substance loading agent associated with a substance storage site, wherein the at least one substance-spreading agent is associated with a spreading vehicle, wherein the predetermined list of transaction types further includes a substance loading transaction, wherein the substance loading agent computing device and the substance-spreading agent computing device execute a smart contract when a quantity of substance is loaded onto the spreading vehicle at the substance storage site, wherein one of the substance loading agent computing device or the substance-spreading agent computing device initiates the smart contract including the quantity of substance, and wherein a respective substance loading transaction with the quantity of substance is added to the blockchain ledger when the other one of the substance loading agent computing device and the substance-spreading agent computing device confirms the smart contract.

3. The road treatment distribution system of claim 1 wherein the at least one administrative agent computing device initiates a first smart contract with the substance-spreading agent computing device including a route to be traversed and a quantity of substance to be spread along the route, and wherein a respective routing transaction comprising the route and the quantity of substance is added to the blockchain ledger when the substance-spreading agent computing device confirms the first smart contract.

4. The road treatment distribution system of claim 3 wherein the at least one substance-spreading agent computing device executes a second smart contract when the quantity of substance has been spread along the route, and wherein a respective substance-deposited transaction is added to the blockchain ledger when the administrative agent computing device confirms the second smart contract.

5. The road treatment distribution system of claim 3 wherein the at least one administrative agent computing device determines the quantity of substance to be spread along the route in response to examination of the blockchain ledger to determine amounts of substance previously spread along the route.

6. The road treatment distribution system of claim 3 wherein the quantity of substance to be spread along the route is comprised of a substance application rate.

7. The road treatment distribution system of claim 1 wherein the at least one substance-spreading agent is comprised of a spreading vehicle, wherein the spreading vehicle is comprised of environmental sensors configured to collect road condition data in a vicinity of the spreading vehicle; wherein the predetermined list of transaction types further includes a environmental data transaction, wherein the substance-spreading agent computing device initiates a smart contract with the administrative agent computing device including the environmental data, and wherein a respective environmental data transaction is added to the blockchain ledger when the administrative agent computing device confirms the smart contract.

8. The road treatment distribution system of claim 1 further comprising:
a plurality of public agent computing devices each operated by a respective public user in a respective user vehicle which includes a respective environmental sensor configured to collect road condition data in a vicinity of the respective user vehicle; and
a public blockchain ledger shared with the nodes within the permissioned blockchain network comprising a plurality of data transactions in which road is condition data collected by the public agent computing devices are stored;
wherein the agent computing devices in the permissioned blockchain network are further configured to conduct the road-substance-related functions using data extracted from the public blockchain ledger.

9. The road treatment distribution system of claim 8 wherein the administrative agent computing device grants a reward to a respective public user when the respective public agent computing device provides the road condition data.

10. The road treatment distribution system of claim 1 wherein the at least one administrative agent is selected from a group including a governmental entity, a fleet manager, a home association, and a property manager.

11. A method of road treatment distribution in which a plurality of agents cooperatively undertake activities in order to apply a substance for treating roadways, comprising the steps of:
interconnecting a plurality of agent computing devices, each operated by a respective agent, as nodes within a permissioned blockchain network, wherein the agents include at least one substance-spreading agent and at least one administrative agent;
sharing a permissioned blockchain ledger shared among the agent computing devices, wherein the blockchain ledger comprises a series of transactions according to the cooperatively undertaken activities, wherein each transaction in the series in blockchain ledger has a respective transaction type according to a predetermined list of transaction types which includes a routing transaction and a substance-deposited transaction;
each of the agent computing devices generating a proposed transaction when undertaking one of the activities;
each of the agent computing devices confirming a proposed transaction record received from another one of the agent computing devices if the respective is activity can be verified;
adding proposed transaction to the blockchain ledger if the proposed transaction has been confirmed; and
each of the agent computing devices conducting road-substance-related functions using data extracted from the blockchain ledger.

12. The method of claim 11 wherein the agents include at least one substance loading agent associated with a substance storage site, wherein the at least one substance-spreading agent is associated with a spreading vehicle, wherein the predetermined list of transaction types further includes a substance loading transaction, wherein the substance loading agent computing device and the substance-spreading agent computing device execute a smart contract when a quantity of substance is loaded onto the spreading vehicle at the substance storage site, wherein one of the substance loading agent computing device or the substance-spreading agent computing device initiates the smart contract including the quantity of substance, and wherein a respective substance loading transaction with the quantity of substance is added to the blockchain ledger when the other one of the substance loading agent computing device and the substance-spreading agent computing device confirms the smart contract.

13. The method of claim 11 wherein the at least one administrative agent computing device initiates a first smart contract with the substance-spreading agent computing device including a route to be traversed and a quantity of substance to be spread along the route, and wherein a respective routing transaction comprising the route and the quantity of substance is added to the blockchain ledger when the substance-spreading agent computing device confirms the first smart contract.

14. The method of claim 13 wherein the at least one substance-spreading agent computing device executes a second smart contract when the quantity of substance has been spread along the route, and wherein a respective substanceis deposited transaction is added to the blockchain ledger when the administrative agent computing device confirms the second smart contract.

15. The method of claim 13 wherein the at least one administrative agent computing device determines the quantity of substance to be spread along the route in response to examination of the blockchain ledger to determine amounts of substance previously spread along the route.

16. The method of claim 13 wherein the quantity of substance to be spread along the route is comprised of a substance application rate.

17. The method of claim 11 wherein the at least one substance-spreading agent is comprised of a spreading vehicle, wherein the spreading vehicle is comprised of environmental sensors configured to collect road condition data in a vicinity of the spreading vehicle; wherein the predetermined list of transaction types further includes a environmental data transaction, wherein the substance-spreading agent computing device initiates a smart contract with the administrative agent computing device including the environmental data, and wherein a respective environmental data transaction is added to the blockchain ledger when the administrative agent computing device confirms the smart contract.

18. The method of claim 11 wherein a plurality of public agent computing devices are each operated by a respective public user in a respective user vehicle which includes a respective environmental sensor configured to collect road condition data in a vicinity of the respective user vehicle, the method further comprising the step of:
sharing a public blockchain ledger among the nodes within the permissioned blockchain network comprising a plurality of data transactions in which road condition data collected by the public agent computing devices are stored;
wherein the agent computing devices in the permissioned blockchain is network conduct the road-substance-related functions using data extracted from the public blockchain ledger.

19. The method of claim 18 wherein the administrative agent computing device grants a reward to a respective public user when the respective public agent computing device provides the road condition data.

20. The method of claim 11 wherein the at least one administrative agent is selected from a group including a governmental entity, a fleet manager, a home association, and a property manager.
